(19) United States
(12) Patent Application Publication
(10) Pub. No.: US 2005/0103283 A1
(43) Pub. Date: May 19, 2005

(54) Pet restraining device

(76) Inventor: Theodore T. Penzak, Sterling Heights, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/977,564

(22) Filed: Oct. 29, 2004

Related U.S. Application Data
(60) Provisional application No. 60/517,207, filed on Nov. 4, 2003.

(51) Int. Cl. A01K 15/04

(52) U.S. Cl. 119/816

(57) ABSTRACT

An animal restraining device for limiting the distance between the front leg of the animal and the corresponding back leg of the animal. The device includes a member releasable engageable with the front leg of the animal and the back leg of the animal. The member can be flexible and can be a chain or formed from fabric. The device substantially prevents the animal from engaging in a running stride but substantially allows the animal to engage in a walking stride.

This application claims priority to provisional patent application Ser. No. 60/517,207, filed Nov. 4, 2003.

### BACKGROUND OF THE INVENTION

1. Field of the Invention

The invention relates to a restraining device for an animal and, more specifically, relates to a device for limiting the stride of an animal.

2. Related Art

It can be desirable to limit the movement of an animal in order to control the animal. A leash is a well-known device for limiting the movement of a pet. A leash falls into one category of pet restraining devices in which the animal is connected to a relatively fixed point by a flexible member. The fixed point can be the hand or wrist of a person or can be rigid structure such as a pole or stake. However, sudden and extreme movement by the animal can cause the leash to break from the fixed point. A cage is another well-known device to limit the movement of an animal such as a pet or an undomesticated animal. A cage falls into another category of pet restraining devices in which a physical space is defined by rigid structural members. However, cages, especially for large animals, are costly and difficult to move.

Many people go to great lengths to train their dogs to behave in a desired manner and to break them of undesirable behavior. For example, it is common for dogs, particularly large breeds, to jump up on their owners and guests which is highly undesirable. Large breeds are also known to jump over fences and other barriers intended to keep them contained.

### SUMMARY OF THE INVENTION

The present invention provides an apparatus and method for restraining a four-legged animal, wherein the distance between the front leg and the back leg of the animal is limited. For example, a member such as a chain can be releasibly connected to the animal's front leg and releasably connected to the animal's back leg. While walking, a four legged animal moves at a walking stride wherein the front and back legs move together in pairs. While running, the stride of the animal changes and the front legs move together and the back legs move together. The maximum distance between the front legs and the back legs increase during running. The member of the present invention can limit the distance between the front and back legs to substantially prevent the animal from reaching a maximum stride associated with running.

Such a device can also be used to keep a dog from jumping up on a person or over barriers by limiting the ability of the animal to raise its front quarters beyond a certain level. Such a device also tames an animal somewhat by lessening the momentum that the animal can build when preparing to jump or lunge forward or upward, making such animals more manageable to handle.

### BRIEF DESCRIPTION OF THE DRAWINGS

These and other features and advantages of the present invention will become more readily appreciated when considered in connection with the following detailed description and appended drawings, wherein:

FIG. 1 is a schematic illustration of an exemplary embodiment of the pet restraining device according to the present invention; and

FIG. 2 is a perspective view of a second exemplary embodiment of the present invention releasably connected to an animal.

### DETAILED DESCRIPTION OF THE PREFERRED EMBODIMENT

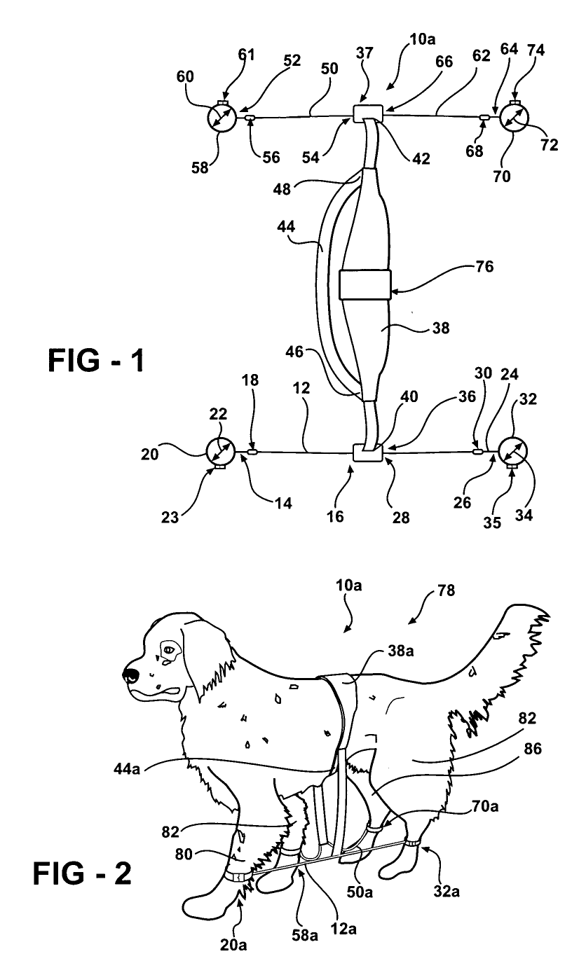

Referring now to FIG. 1, the present invention provides an animal restraining device including a limiting device 10 for limiting a distance between a first front leg of an animal and a corresponding back leg of an animal. The device 10 can include a first flexible member 12 having a first end 14 and a second end 16 and defining a first length extending between the first end 14 and the second end 16. Preferably, the first member 12 is flexible and can be formed from chain or fabric. The first member 12 can be formed from elastic fabric or substantially inelastic fabric. The first member 12 is releasably attachable to the first front leg of the animal. The device 10 includes a first restraining collar 20 positioned at the first end 14. The collar 20 defines a diameter 22 corresponding to the size of the animal's front leg. The diameter 22 can be changed by a diameter adjuster 23 such as a buckle, a clasp or velcro. Preferably, the collar 20 is positioned proximate the paw of the animal in operation.

The device 10 also includes a first length adjuster 18 operably associated with the first length and operable to change the first length. The first length can be changed in response to the size of the animal to be restrained. The structure and operation of the length adjuster 18 and can be selected based on the structure of the first member 12. For example, where the first member 12 is formed from fabric, the length adjuster 18 can be a buckle or can be velcro. Alternatively, where the first member 12 is a chain, the length adjuster 18 can be a ring for engaging two chain links with respect to one another.

A device 10 can also include a second member 24 having a first end 26 and a second end 28. A second restraining collar 32 can be disposed adjacent the first end 26. The collar 32 can define a diameter 34 and also include a diameter adjuster 35. A second length adjuster 30 can be operably associated with the second length and operable to change the second length. The second member 24 can be substantially the same as the first member 12. Similarly, the features and components of the invention described in association with the first member 12, such as the length adjuster 18 and the restraining collar 20, are applicable to the features and components of the invention described in association with the second member 24, such as the length adjuster 30 and the restraining collar 32.

The first and second members 12, 24 can be integrally formed with respect to one another. Alternatively, the second end 16 of the first member 12 can be connected to the second end 28 of the second member 24. Preferably, the combined lengths of the first member 12 and second member 24 are selected to correspond to the desired walking stride of the animal.

As shown in FIG. 1, the exemplary embodiment of the invention includes a retractor 36 connected to the second end 16 of the first member 12 and a second end 28 of the second member 24. The retractor 36 can retract or shorten the length of the first member 12 and/or shorten the length of the second member 24. In other words, the retractor 36 can move the restraining collars 20, 32 closer together and can minimize the distance between the front and back legs of the animal. The retractor 36 can be controlled remotely. The retractor 36 can be desirable where temporary incapacitation of the animal is desired. For example, during the transport of an undomesticated animal, the retractor 36 can be engaged if the animal endangers itself or endangers humans. The front and back legs can be drawn together to prevent the animal from walking or standing. The retractor 36 can include structure such as a reel-type device that can draw ends of the members 12, 24 into a housing. The reel-type device can include a spring-loaded cartridge similar to tension loading devices in automotive cargo netting applications.

The device also includes a third flexible member 50 having a first end 52 and a second end 54. The third member 50 can be operably associated with a length adjuster 56 and a collar 58. The collar 58 can be positioned adjacent the first end 52 and define a diameter 60. A diameter adjuster 61 can selectively adjust the diameter 60. The features and operation of the third member 50 and related components such as the length adjuster 56 and restraining collar 58 can be similar to the features and operations of the first member 12 and the components associated with the first member 12 such as the length adjuster 18 and the restraining tower 20.

The device 10 also includes a fourth member 62 having a first end 64 and a second end 66. The fourth member 62 is operably associated with a length adjuster 68 and a restraining collar 70. The restraining collar 70 defines a diameter 72 and is positioned adjacent the second end 64. The diameter 72 can be changed by a diameter adjuster 74. The features and operation of the fourth member 62 and the components associated with the fourth member 62 such as the length adjuster 68 and the restraining collar 70 can be similar to the features and operation of the first member 12 and the components associated with the first member 12 such as the length adjuster 18 and the restraining collar 20.

A second retractor 37 can be positioned between the third and fourth members 50, 62 to shorten the length of the third and fourth members 50, 62. The features and operations of the retractor 37 can be substantially similar to the features and operation of the retractor 36. The retractors 36, 37 can be controlled to engage concurrently or independently as desired. In addition, the retractors 36, 37 can be engaged to release some or all of the lengths of the members 12, 24, 50, 62 after the particular lengths have been retracted.

The device 10 also includes a first cross member 38 having a first end 40 and a second end 42. The cross member 38 can connect the retractors 36, 37 at the first end 40 and the second end 42, respectively. Alternatively, the cross member 38 can connect the first and second members 12, 24 with the third and fourth members 50, 62. The cross member 38 can extend over the animal's back in operation. The cross member 38 can be desirable to prevent the flexible members 12, 24, 50, 62 from being dragged along the ground and causing the animal to stumble.

The device can also include the second cross member 44 having a first end 46 and a second end 48. The second cross member 44 can be connected to the retractors 36, 37 at the first end 40 and the second end 42, respectively. Alternatively, the second cross member 44 can be connected to points along the length of the cross member 38. The second cross member 44 can extend underneath the animal in operation. The second cross member 44 can be desirable to enhance the positioning of the first cross member 38. For example, the members 38, 44 can cooperate to enhance the likelihood that the member 38 is maintained at a desired position along the animal's body. One or both of the cross members 38, 44 can be elastic to further enhance the positioning of the device 10 with respect to the animal.

The cross member 38 can support a global position indicator 76. The indicator 76 can include a global position sensor operable to receive signals from a global position system (GPS) satellite. The indicator 76 can also include a processor operable to receive signals from the sensor corresponding to the global position of the indicator 76. The indicator 76 can also include a transmitter operable to emit a signal corresponding to the global position of the indicator 76 to a remote device. The indicator 76 can be desirable in the event that the animal moves to an undetermined location.

Referring now to FIG. 2, a second exemplary embodiment of the invention includes a device 10a engaged with respect to an animal 78. The device 10a includes first and second collars 20a, 32a, and a member 12a extending between the collars 20a, 32a. The member 12a can be formed from a chain, from elastic fabric, from substantially inelastic fabric, or from any combination of chain and fabric.

The collar 20a is releasibly associated with a first front leg 80 of the animal 78 and the collar 32a is releasibly associated with a first corresponding back leg 82 of the animal 78. The device 10a also includes a second member 50a extending between the collars 58a and 70a. The collar 58a is releasibly engaged with respect to a second front leg 84 of the animal 78. The collar 70a is releasibly associated with respect to a second corresponding back leg 86 of the back leg of the animal 78.

The members 12a and 50a, and associated collars 20a, 32a, 58a, 70a limit movement of the animal's front legs 80, 84, with respect to the animal's back legs 82, 86. The lengths of the members 12a, 50a can be selectively determined based on the size of the animal and/or the desired walking stride of the animal 78. The device 10a can be desirable to train the animal to move at a desired pace and at a desired stride. For example, the device 10a can be advantageous to train the animal for a dog show or for training show or race horses. Moreover, by limiting the stride of the animal between its front and back legs, the device can restrict the ability of the animal to jump upon humans or other animals, as doing so would require the animal to extend its front legs beyond the distance allowed for by the restraining device, why still enabling the animal to walk and move about in a desired, controlled fashion. In addition, the device 10a can be used to control the animal during movement in public places. For example, the length of the members 12a, 50a can allow the animal to walk, while also preventing the animal from breaking into a running stride. Generally, a four legged animal engages in two different moving motions, a walking stride and a running stride. During the running stride, the front and back legs of the animal are spaced further apart than in the walking stride. Although not shown in FIG. 2, the device 10a can also include a global position indicator and one or more retractors.

Obviously, many modifications and variations of the present invention are possible in light of the above teachings. It is, therefore, to be understood that within the scope of the appended claims, the invention may be practiced otherwise than as specifically described. The invention is defined by the claims.

1. A method for restraining a four-legged animal comprising the steps of:
securing a restraining device having a length between a first front leg of an animal and a corresponding back leg of the animal; and
limiting a distance between the first front leg of an animal and the corresponding first back leg of the animal with the length of the restraining device.

2. The method according to claim 1 including limiting a distance between a second front leg of the animal and a corresponding second back leg of the animal with a second restraining device having a second length.

3. The method according to claim 1 wherein said limiting step is further defined as selectively setting the maximum distance between the first front leg and the corresponding first back leg.

4. The method according to claim 1 wherein said limiting step includes connecting a first flexible member to the first front leg and connecting the first flexible member to the first back leg.

5. The method according to claim 4 wherein said connecting step includes connecting a chain between the front and corresponding back legs.

6. The method according to claim 1 including selecting the distance in response to a size of the animal.

7. The method according to claim 1 including selecting the distance in response to a walking stride of the animal.

8. The method according to claim 1 including shortening the distance to a second distance after the limiting step.

9. The method according to claim 8 wherein the shortening step is further defined as minimizing the distance between the front and corresponding back legs.

10. A four-legged animal restraining device comprising:
a restraining device having a length and extending between a first front leg of an animal and a corresponding back leg of the animal; and
a device for selectively changing the length of the restraining device between the first front leg of the animal and the corresponding back leg of the animal.

11. The animal restraining device according to claim 10 wherein said restraining device includes a flexible member releasibly attachable to the first front leg and the corresponding back leg of the animal.

12. The animal restraining device according to claim 11 wherein said flexible member is elastic.

13. The animal restraining device according to claim 11 wherein said flexible member is a chain.

14. The animal restraining device according to claim 11 wherein the flexible member includes a first member releasibly attachable to the front leg and a second member releasably attachable to the back leg, wherein the first and second members are operably associated with one another.

15. The animal restraining device according to claim 14 including a retractor positionable between said first and second members.

16. The animal restraining device according to claim 11 wherein said device for selectively changing the length of the restraining device includes one of a buckle and velcro operable to adjust the length of said flexible member.

17. The animal restraining device according to claim 16 including a retractor operable to shorten said length of said flexible member.

18. The animal restraining device according to claim 10 including a global position sensor and transmitter.

19. A four-legged animal restraining device comprising:
a first flexible member having a first end and a second end and a first length extending between said first end and said second end;
a first length adjuster operably associated with said first length and operable to change said first length;
a first restraining collar positioned at said first end and having a first diameter;
a first diameter adjuster operably associated with said first restraining collar and operable to change said first diameter;
a second flexible member having a first end and a second end and a second length extending between said first and second ends of said second flexible member;
a second length adjuster operably associated with said second length and operable to change said second length;
a second restraining collar positioned at said first end of said second flexible member and having a second diameter;
a second diameter adjuster operably associated with said second restraining collar and operable to change said second diameter;
a first retractor connected to said second end of said first flexible member and to said second end of said second flexible member and operable to retract said first and second lengths;
a first cross member having first and second ends and extending from said retractor at said first end of said first cross member;
a second cross member having first and second ends and extending from said retractor at said first end of said second cross member;
a third flexible member having a first end and a second end and a third length extending between said first and second ends of said third flexible member and said second end of said third flexible member connected to said second ends of said first cross member and said second cross member;
a third length adjuster operably associated with said third length and operable to change said third length;
a third restraining collar positioned at said first end of said third flexible member and having a third diameter;
a third diameter adjuster operably associated with said third restraining collar and operable to change said third diameter;
a fourth flexible member having a first end and a second end and a fourth length extending between said first and second ends of said fourth flexible member and said second end of said fourth flexible member connected to said second ends of said first cross member and said second cross member;
a fourth length adjuster operably associated with said fourth length and operable to change said fourth length;
a fourth restraining collar positioned at said first end of said fourth flexible member and having a fourth diameter;
a fourth diameter adjuster operably associated with said fourth restraining collar and operable to change said fourth diameter; and
a position indicator including a position sensor and a position signal emitter.

20. The animal restraining device of claim 19 wherein each of said first and second retractors includes a control unit having a signal receiving unit and a member moving mechanism and a processor wherein said signal receiving unit is operable to receive a signal and communicate said signal to said processor and said processor is operable to receive said signal an control said member moving mechanism in response to said signal to shorten at least one of said first, second, third and fourth lengths.
